(19) United States
(12) Patent Application Publication
(10) Pub. No.: US 2025/0335720 A1
(43) Pub. Date: Oct. 30, 2025

(54) LANGUAGE MODEL TRAINING DEVICE, DIALOGUE DEVICE AND TRAINED LANGUAGE MODEL

(71) Applicant: National Institute of Information and Communications Technology, Tokyo (JP)

(72) Inventors: Jonghoon OH, Tokyo (JP); Yoshihiko ASAO, Tokyo (JP); Kentaro TORISAWA, Tokyo (JP); Junta MIZUNO, Tokyo (JP); Kiyonori OTAKE, Tokyo (JP)

(73) Assignee: National Institute of Information and Communications Technology, Tokyo (JP)

(21) Appl. No.: 18/832,428

(22) PCT Filed: Jan. 17, 2023
(86) PCT No.: PCT/JP2023/001155

§ 371 Date: Dec. 20, 2024

(30) Foreign Application Priority Data
Feb. 28, 2022 (JP) 2022-029327

(51) Int. Cl. G06F 40/40; G06F 40/35

(52) U.S. Cl. CPC G06F 40/40; G06F 40/35

(57) ABSTRACT

A language model training device, independent of speech synthesis and speech recognition performances, allowing training of a large-scale language model at low computational cost, includes: a converting means for converting natural language text to output a sequence of phonetic letters; and a training means for training a language model using the text and the sequence of phonetic letters output from the converting means.

### TECHNICAL FIELD

The present invention relates to a technique for humans to interact with a machine using natural language and, more specifically, to a language model training device, a dialogue device, and a trained language model for training a language model that is robust against errors in speech recognition. The present application claims convention priority on a Japanese Patent Application No. 2022-029327 filed on Feb. 28, 2022, and incorporates the descriptions of this Japanese application in its entirety.

### BACKGROUND ART

Recently, language models such as BERT (Bidirectional Encoder Representation from Transformers) that are pre-trained by using large-scale text are attracting attention. After pre-training, these language models can be fine-tuned for individual tasks, and they achieve the best performance on various language processing tasks. Therefore, these models are evaluated as being highly versatile and effective.

On the other hand, for human-machine interaction through natural language, speech recognition is an essential technique. In speech recognition, however, it is difficult to consider audibly similar features and, even when the language model mentioned above is used, robust language processing has its limit. By way of example, if “ASA” (“morning” in Japanese) and “KASA” (“umbrella” in Japanese) happen to be mis-recognized, smooth human-machine interaction would fail.

Non-Patent Literature 1 proposes a solution to such a problem. Non-Patent Literature 1 is directed to pre-training of a language model such as BERT used for speech recognition.

Referring to FIG. 1, a language model training system 50 disclosed in Non-Patent Literature 1 converts a reference sentence 60 to speech 64 by TEXT-TO-SPEECH (speech synthesis) 62. Synthesized noise 66 is added to speech 64 and ambient noise 68 is further added to speech 64, and thus noisy speech 70 is obtained. Language model training system 50 converts the noisy speech 70 back to transcript 74 by SPEECH-TO-TEXT (speech recognition) 72. The transcript 74 involves noise resulting from the process of TEXT-TO-SPEECH 62, synthesized noise 66, ambient noise 68 and SPEECH-TO-TEXT 72.

Language model training system 50 further converts transcript 74 to a phoneme sequence 78 corresponding to a word sequence of transcript 74, through an LAS (Listen-Attend-Spell) model 76. The phoneme sequence 78 includes phonetic symbols. Using the phoneme sequence 78 and the word sequence of transcript 74, language model training system 50 conducts pre-training 80 of a language model 82. In Non-Patent Literature 1, BERT is used as the language model 82, and the pre-trained language model 82 is referred to as phoneme BERT.

### CITATION LIST

### Non-Patent Literature

NPL 1: Mukuntha Narayanan Sundararaman, Ayush Kumar, Jithendra Vepa, Phoneme-BERT: Joint Language Modelling of Phoneme Sequence and ASR (Automatic Speech Recognition) Transcript, in Proceedings of Interspeech 2021

### SUMMARY OF INVENTION

### Technical Problem

In the technique disclosed in Non-Patent Literature 1, however, a series of speech processing including speech synthesis and speech recognition is necessary to prepare data for pre-training the language model 82. Generally, speech processing costs much higher than text-only language processing. In order to attain high performance in a large-scale language model such as BERT, billions of sentences are known to be necessary in the pre-training. Therefore, it is practically difficult to apply the technique disclosed in Non-Patent Literature 1 to training of a large-scale language model such as BERT.

Further, the language model obtained by the technique disclosed in Non-Patent Literature 1 has a problem that it highly depends on the speech synthesizer and the speech recognizer used for preparing the training data. Therefore, when the speech synthesizer or the speech recognizer is to be changed after completion of language model training, it becomes necessary to re-train all over again. Further, the performance of the language model is much influenced by the performances of the speech synthesizer and the speech recognizer used for preparing the training data.

Therefore, an object of the present invention is to provide a language model training device, a dialogue device and a trained language model that are independent from the performances of speech synthesis and speech recognition and that allow training of a large-scale language model with low computational cost.

### Solution to Problem

According to a first aspect, the present invention provides a language model training device, including: a converting means for converting natural language text to output a sequence of phonetic letters; and a training means for training a language model using the text and the sequence of phonetic letters output from the converting means.

Preferably, the training means includes: training data forming means for forming training data for training the language model by combining the text and the sequence of phonetic letters output from the converting means; and a pre-training means for pre-training the language model using the training data.

More preferably, the language model training device further includes: a noise-adding means for adding noise to the sequence of phonetic letters to generate a noise-added sequence of phonetic letters; a training data forming means for forming training data for fine-tuning the language model pre-trained by the pre-training means, using the text, the sequence of phonetic letters and the noise-added sequence of phonetic letters; and a fine-tuning means for fine-tuning the pre-trained language model by using the training data.

Further preferably, the language model includes a pre-trained language model; the training means includes: a noise-adding means for adding noise to the sequence of phonetic letters to generate a noise-added sequence of phonetic letters; a training data forming means for forming training data for fine-tuning the language model pre-trained by the pre-training means, using the text, the sequence of phonetic letters and the noise-added sequence of phonetic letters; and a fine-tuning means for fine-tuning the pre-trained language model by using the training data.

Preferably, the language model includes a pre-trained language model; the training means includes: a noise-adding means for adding noise to the sequence of phonetic letters to generate a noise-added sequence of phonetic letters; an additional training data forming means for forming additional training data for additionally training the pre-trained language model, using the text, the sequence of phonetic letters and the noise-added sequence of phonetic letters; and an additional pre-training means for additionally pre-training the pre-trained language model using the training data.

The noise-adding means may include a replacing means for replacing part of the sequence of phonetic letters with one or more phonetic letters to newly generate noise-added sequence of phonetic letters. The replacing means may include a word replacing means, for replacing, of the sequence of phonetic letters, each of one or more phonetic letters corresponding to one or more words selected at random with a prescribed ratio from words in the text with one or more phonetic letters representing a word different from but having reading similar to the word or words, to newly generate noise-added sequence of phonetic letters. The replacing means may include a symbol replacing means for replacing, of the phonetic letters forming the sequence of phonetic letters, each of one or more phonetic letters selected at random with a prescribed ratio, with another phonetic letter different from but having reading similar to the phonetic letter or letters, to newly generate noise-added sequence of phonetic letters. The converting means may include a morpheme analyzing means for conducting morphological analysis of the text and for outputting a phonetic letter sequence corresponding to the text. The language model is a Japanese language model, and the morpheme analyzing means may include a HIRAGANA output means for conducting morphological analysis of the text and outputting, as the phonogram sequence, a HIRAGANA sequence corresponding to the text.

According to a second aspect, the present invention provides a dialogue device realizing speech-based dialogue with a user, including: a trained language model generated by machine learning using at least natural language text and a sequence of phonetic letters obtained by converting the text; a semantic interpretation module with the trained language model, for receiving as an input speech information of the user; and an utterance/response module for receiving as an input the speech information of the user and for executing a dialogue with the user under control of the semantic interpretation module.

According to a third aspect, the present invention provides a trained language model generated by machine learning, using at least natural language text and a sequence of phonetic letters obtained by converting the text.

According to a fourth aspect, the present invention provides a computer program causing a computer to function as: a converting means for converting text for speech recognition to a sequence of phonetic letters; and a training means for training a language model using the text and the sequence of phonetic letters converted by the converting means.

The foregoing and other objects, features, aspects, and advantages of the present invention will become more apparent from the following detailed description of the present invention when taken in conjunction with the accompanying drawings.

### BRIEF DESCRIPTION OF DRAWINGS

FIG. 1 schematically shows a configuration of a conventional language model training system.

FIG. 2 is a block diagram schematically showing a configuration of the language model training device in accordance with a first embodiment of the present invention.

FIG. 3 schematically shows a configuration of training data used in the language model training in accordance with the first embodiment of the present invention.

FIG. 4 is a block diagram schematically showing steps of training the language model in accordance with the first embodiment of the present invention.

FIG. 5 is a schematic diagram illustrating the contents of MLM (Masked Language Modeling) when the language model is trained in accordance with the first embodiment of the present invention.

FIG. 6 is a block diagram showing a functional structure of a noise-adding unit 124 in accordance with the first embodiment of the present invention.

FIG. 7 shows an example of a noise-adding dictionary used for adding noise in the first embodiment of the present invention.

FIG. 8 is a flowchart showing a control structure of a program realizing noise-addition in accordance with the first embodiment of the present invention.

FIG. 9 shows a specific example of noise addition to training data in accordance with the first embodiment of the present invention.

FIG. 10 is a functional block diagram of a dialogue device using the trained language model in accordance with the first embodiment of the present invention.

FIG. 11 shows examples of answers in a YES/NO determining task using the trained language model in accordance with the first embodiment of the present invention.

FIG. 12 shows examples of speech recognition results of responses from the user in the YES/NO determining task using the language model in accordance with the first embodiment of the present invention.

FIG. 13 is an illustration showing the configuration of data set used in experiments related to the present invention.

FIG. 14 shows, in the form of a table, settings of fine tuning for the YES/NO determining task of the language model trained by the present invention.

FIG. 15 shows, in the form of a table, experimental results of the YES/NO determining task using the language model trained by the present invention.

FIG. 16 shows an appearance of a computer system realizing the language model training device in accordance with the present invention.

FIG. 17 is a block diagram showing hardware configuration of the computer system shown in FIG. 16.

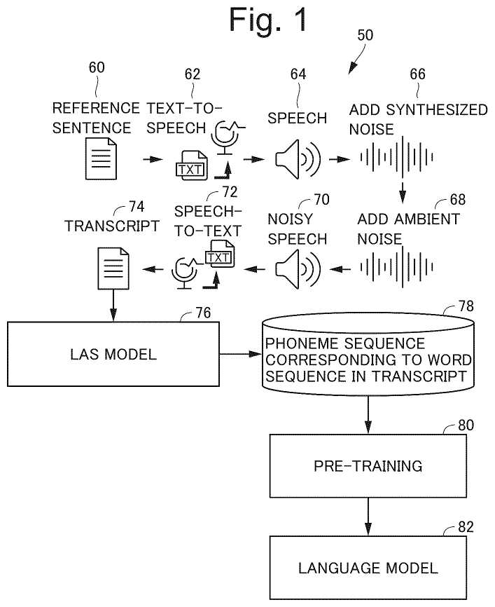

### DESCRIPTION OF EMBODIMENTS

In the following description and in the drawings, the same components are denoted by the same reference characters. Therefore, detailed description thereof will not be repeated.

### I. First Embodiment

### 1. Configuration

### A. Overall Configuration

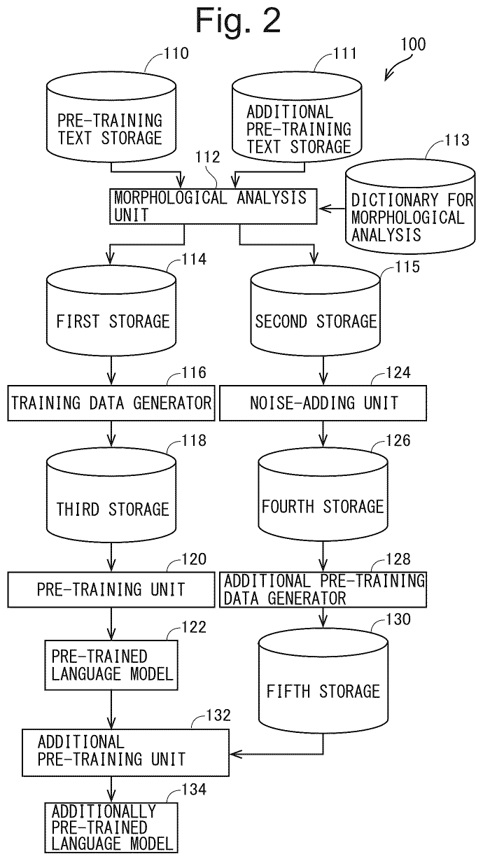

FIG. 2 shows, in a block diagram, overall configuration of a language model training device 100 in accordance with the first embodiment of the present invention.

Referring to FIG. 2, the language model training device 100 is for pre-training a large-scale language model. Language model training device 100 includes pre-training text storage 110 for storing original text for pre-training, and additional pre-training text storage 111 for storing original text for additional pre-training. Here, both training texts are sentences of Japanese word sequences.

Language model training device 100 further includes: a dictionary 113 for morphological analysis, referred to at the time of morphological analysis of the text; and a morphological analysis unit 112 performing morphological analysis of each sentence in the text stored in pre-training text storage 110 with reference to dictionary 113 for morphological analysis, converting the results to phonetic letter sequences of HIRAGANA (sequence of Japanese phonetic letters) and outputting as a word sequence/phonetic letter sequence pair, and performing the same process on the text stored in additional pre-training text storage 111 and outputting the results as a word sequence/phonetic letter sequence pair.

Language model training device 100 further includes: first storage 114 for storing the word sequence/phonetic letter sequence pair output by morphological analysis unit 112 after processing the text in pre-training text storage 110; and second storage 115 for storing the word sequence/phonetic letter sequence pair output by morphological analysis unit 112 after processing the text in additional pre-training text storage 111.

Language model training device 100 further includes: a training data generator 116 for generating training data for pre-training the language model from the word sequence/phonetic letter sequence pairs stored in the first storage 114, and third storage 118 for storing the training data generated by the training data generator 116. The configuration of training data generator 116 will be described later.

Language model training device 100 further includes a pre-training unit 120 for pre-training the large-scale language model by using the training data stored in the third storage 118, and for generating a pre-trained language model 122. In the present embodiment, BERT is used as the pre-trained language model 122, as described above.

Language model training device 100 further includes: a noise-adding unit 124 for adding noise to each of the word sequence/phonetic letter sequence pairs stored in the second storage 115 and outputting the noise-added pairs as noise-added word sequence/HIRAGANA pairs; and fourth storage 126 for storing the noise-added word sequence/HIRAGANA pairs output from noise-adding unit 124 and the original word sequence/HIRAGANA pairs before adding the noise, respectively.

Language model training device 100 further includes: an additional pre-training data generator 128 for generating training data for additional pre-training from each of the word sequence/phonetic letter sequence pairs stored in the fourth storage 126; and fifth storage 130 for storing the training data generated by additional pre-training data generator 128.

Language model training device 100 further includes: an additional pre-training unit 132 executing additional pre-training of pre-trained language model 122 by using the training data stored in the fifth storage 130, and for generating an additionally pre-trained language model 134.

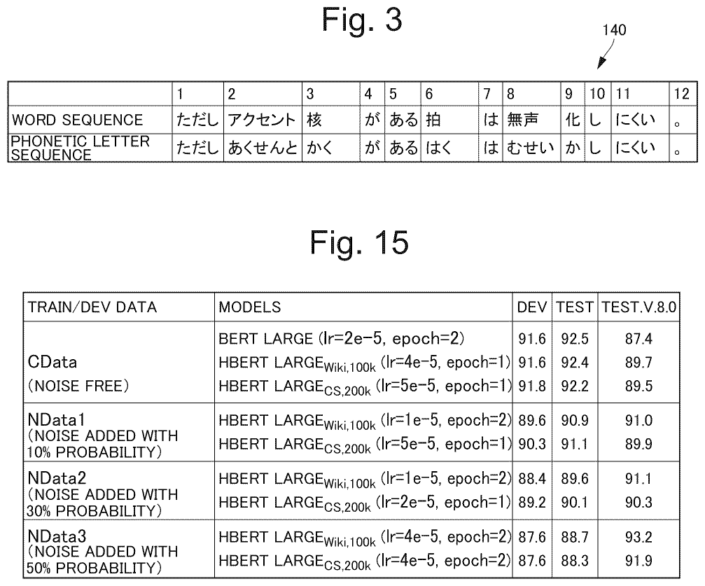

FIG. 3 shows a word sequence/phonetic letter sequence pair 140 as an example of word sequence/phonetic letter sequence pairs stored in the first storage 114 shown in FIG. 2. Referring to FIG. 3, word sequence/phonetic letter sequence pair 140 includes a word sequence and a phonetic letter sequence representing how the word sequence is read. Each word and its reading are associated with each other.

### B. Pre-Training

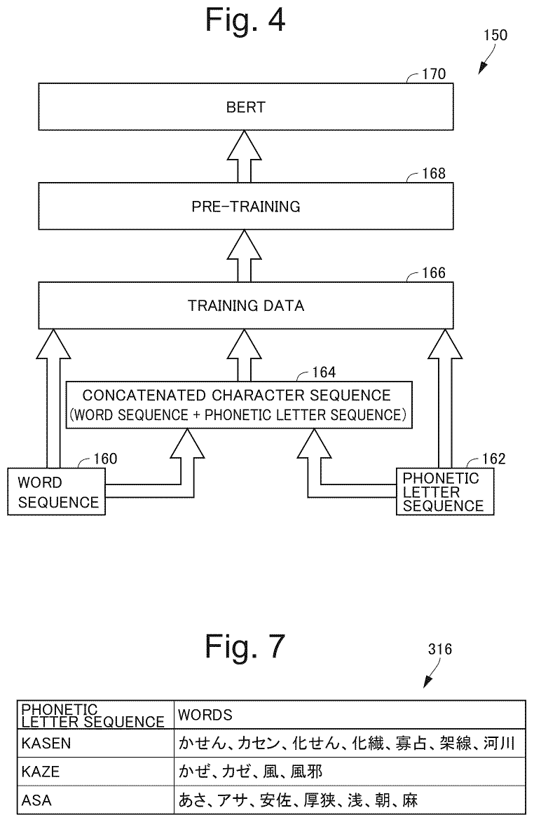

FIG. 4 shows the training process 150 for training pre-trained language model 122 and additionally pre-trained language model 134 shown in FIG. 2. The process is the same for pre-training and additional pre-training. In FIG. 4, in order to commonly represent the pre-trained language model 122 and additionally pre-trained language model 134, the language model as the object of training is represented by BERT 170.

Referring to FIG. 4, in the training process 150, a word sequence 160 in the word sequence/phonetic letter sequence pair 140, a concatenated character sequence 164 obtained by concatenating word sequence 160 and a phonetic letter sequence 162, and the phonetic letter sequence 162, concatenated in this order, are used as training data 166 for BERT 170. This process is done by training data generator 116 shown in FIG. 2 in pre-training, and by additional pre-training data generator 128 shown in FIG. 2 in additional pre-training. In the training process 150, further, BERT 170 is subjected to pre-training 168 in a conventional manner.

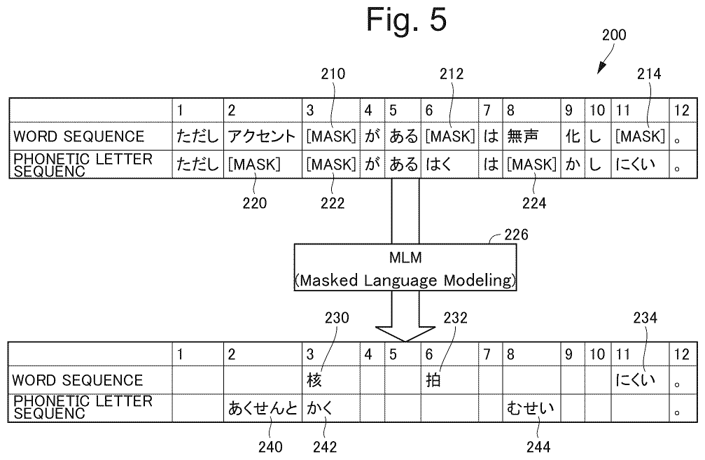

In the pre-training according to the present embodiment, MLM and NSP (Next Sentence Prediction), both well-known as the manner of pre-training BERT, are used. As shown in FIG. 5, in the present embodiment, in MLM 226, both the word sequence and the phonetic letter sequence are masked, and BERT 170 is trained through inference of word or reading of the masked portion. Only the words, or only the readings may be masked.

Specifically, referring to FIG. 5, training data 200 includes a word sequence and a phonetic letter sequence. At the time of pre-training, by way of example, the third, sixth and eleventh words in the word sequence are masked by masks 210, 212 and 214. Similarly, phonetic letters of phonetic letter sequence are masked by masks 220, 222 and 224. Using the training data 200, BERT 170 is trained to be able to estimate the original words 230, 232 and 234 and original readings 240, 242 and 244.

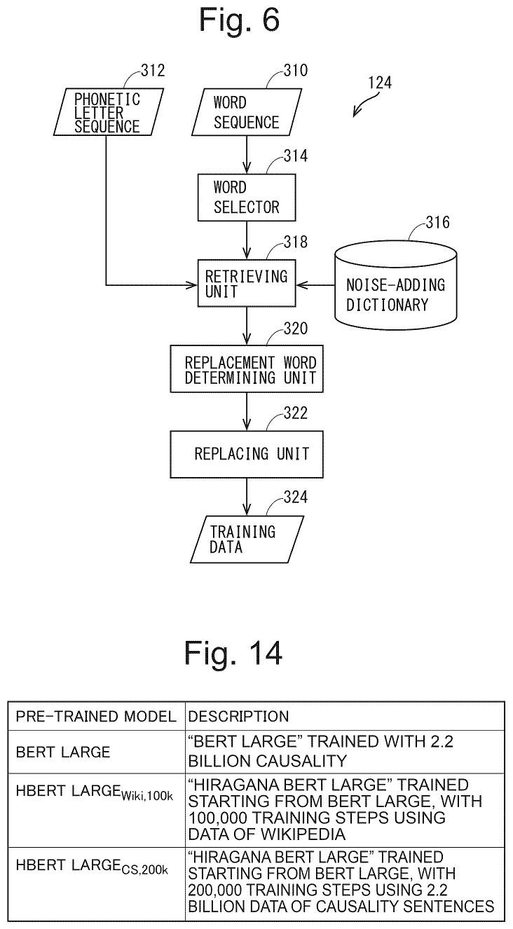

FIG. 6 is a block diagram of noise-adding unit 124. Referring to FIG. 6, noise-adding unit 124 includes a noise-adding dictionary 316. In the present embodiment, noise-adding dictionary 316 is formed by using such words in the vocabulary used for pre-training that have a certain frequency equal to or higher than a prescribed value.

Further, in the present embodiment, the words registered in noise-adding dictionary 316 are those formed of KANJI, HIRAGANA and KATAKANA characters whose length of reading has a prescribed value (for example, 2) or more.

FIG. 7 shows a part of noise-adding dictionary 316. Referring to FIG. 7, it is possible in noise-adding dictionary 316 to find a word that corresponds to phonemes (phonetic letter sequence) of a word. Specifically, when a phonetic letter sequence (such as “KASEN”) is given, words that have the corresponding phonetic letter sequence ( [symbol] (chemical fiber) [symbol] (oligopoly) [symbol] [symbol] (wiring) [symbol] (river) can be retrieved from noise-adding dictionary 316.

Returning to FIG. 6, noise-adding unit 124 further includes: a word selector 314 receiving word sequence 310 and selecting therefrom with a certain ratio, a word or words to which noise is to be added; and a retrieving unit 318 for extracting, for each of the words selected by word selector 314, its phonetic letter sequence from phonetic letter sequence 312, and extracting all words of which phonetic letter sequence has one or two edit distances from the extracted phonetic letter sequence from noise-adding dictionary 316. Here, as shown in FIG. 7, a plurality of words may be extracted from noise-adding dictionary 316 for some phonetic letter sequences.

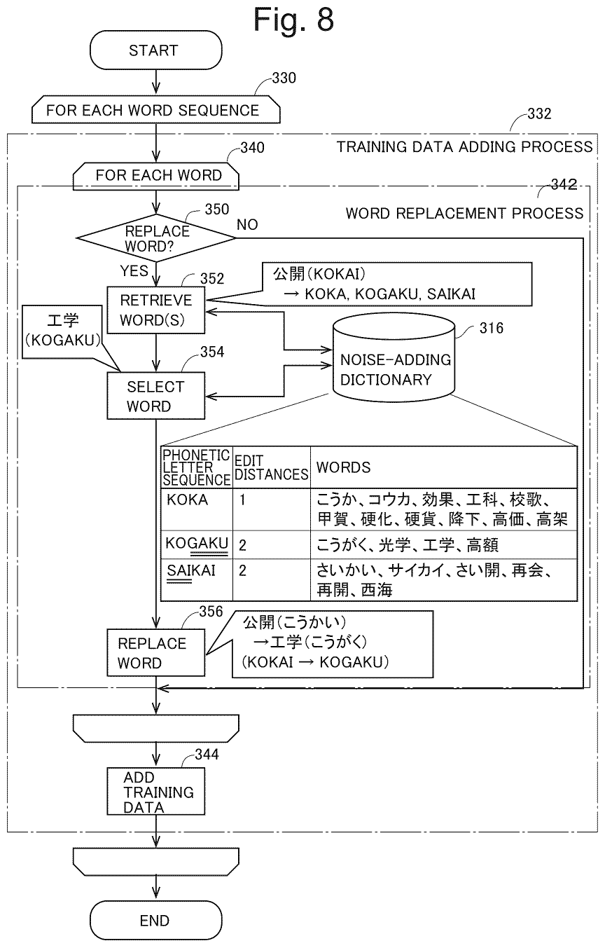

Noise adding unit 124 further includes: a replacement word determining unit 320 for selecting, when a plurality of words are extracted by retrieving unit 318, one word therefrom and determining the first selected word to be the word for replacement; and a replacing unit 322 for replacing the first selected word and its phonetic letter sequence with the word determined by replacement word determining unit 320 and its phonetic letter sequence, in accordance with the determination of replacement word determining unit 320, and outputting the result as training data 324. FIG. 8 is a flowchart showing a control structure of a program realizing the noise-adding unit 124 shown in FIG. 6 by a computer. Referring to FIG. 6, the program includes a step 330 of executing the following training data adding process 332 for each word sequence of the whole training data stored in the second storage 115 shown in FIG. 2.

Training data adding process 332 includes: a step 340 of executing the following word replacement process 342 for each word included in the word sequence under processing; and a step 344 of adding the new data obtained at step 340 to the training data. Word replacement process 342 includes: a step 350 of determining whether or not a word that is being processed is to be replaced with noise, and branching the control flow depending on the result of determination; and a step 352, executed when the determination at step 350 is in the positive, of retrieving a word of which phonetic letter sequence has one or two edit distances from the phonetic letter sequence of word that is being processed, from noise-adding dictionary 316.

For example, assume that the word that is being processed is “KOKAI ( [symbol] (publication))”. Then, from noise-adding dictionary 316, words having the edit distance of one or two from the phonetic letter sequence “KOKAI” are retrieved at step 352. Here, assume that “KOKA” is an example having the edit distance of one and “KOGAKU” and “SAIKAI” are examples having the edit distance of two, from “KOKAI.” Then, 11 words shown in FIG. 8 that have the phonetic letter sequence “KOKA” are retrieved from noise-adding dictionary 316. Likewise, four words having the phonetic letter sequence “KOGAKU” and six words having the phonetic letter sequence “SAIKAI” are respectively retrieved from noise-adding dictionary 316. Naturally, the words shown in FIG. 8 are examples, and phonetic letter sequences to be retrieved may be larger in number and, in that case, the number of the retrieved words also increases.

The program further includes: a step 354 of selecting at random one word from the one or more words taken out at step 352; and a step 356 of replacing, using the word selected at step 354, a word under processing in the word sequence that is being processed as well as the phonetic letter sequence corresponding to the word, and ending the word replacement process 342. When the determination at step 350 is in the negative, nothing is done on the word that is being processed, in the word replacement process 342. Specifically, in the word replacement process 342, if the determination at step 350 is in the positive, the original word, a word of different phonetic letter sequence and its phonetic letter sequence, are added as noise to the word sequence that is under processing.

Though “edit distance” is indicated in the details of noise-adding dictionary 316 in FIG. 8, the edit distance is not itself included in noise-adding dictionary 316. The edit distance is calculated in accordance with the phonetic letter sequence of the original word and the phonetic letter sequence of each word in noise-adding dictionary 316. In the present embodiment, the edit distance between two-character sequences means the minimum value of the number of operations of insertion, deletion and replacement required to convert one character sequence to another.

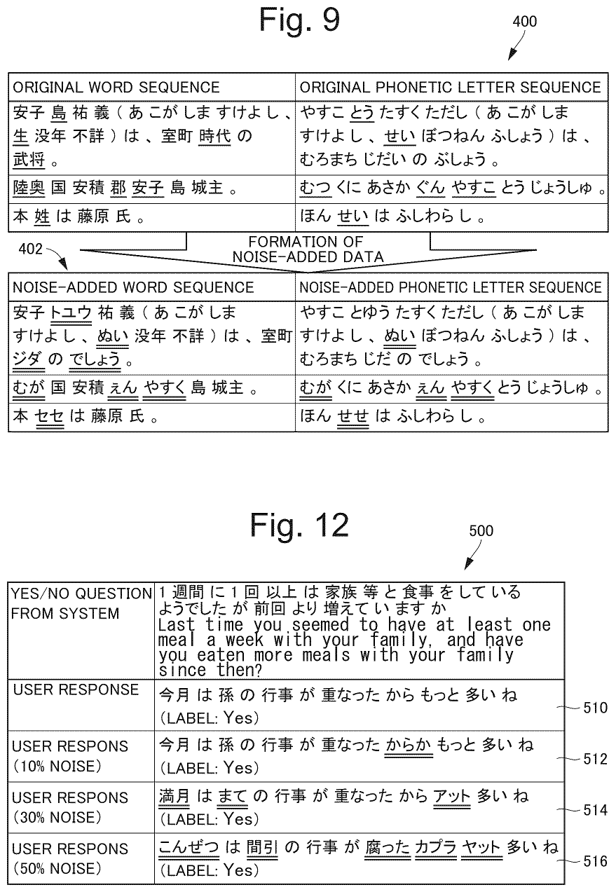

FIG. 9 shows an example of word sequences obtained by adding noise to a word sequence. The word sequence and phonetic letter sequence set 400 on the upper part of FIG. 9 represents the original word sequences. The word sequence and phonetic letter sequence set 402 on the lower part of FIG. 9 represents noise-added word sequences.

In the example shown in FIG. 9, of the phonetic letter sequence set 400, underlined portions are the words as the object of replacement and their readings. Of the phonetic letter sequence set 402, double-underlined portions are the replaced words and their phonetic letter sequences. As can be seen from the example shown in FIG. 9, noise-added phonetic letter sequence set 402 data is quite similar to error-ridden results of speech recognition. In the present embodiment, by replacing a phonetic letter sequence corresponding to a word with a reading of a different word, training data including errors similar to errors of speech recognition can be generated.

### 2. Operation

Referring to FIGS. 2 to 9, language model training device 100 having the above-described configuration operates as follows. In pre-training text storage 110 of language model training device 100, original sentences of pre-training text are stored in advance. Likewise, original sentences of additional pre-training text are stored in additional pre-training text storage 111. In the following, first, the operation of language model training device 100 at the time of pre-training will be described, followed by the operation of language model training device 100 at the time of additional pre-training.

### A. Pre-Training

In the pre-training, morphological analysis unit 112 performs the following process on each of the sentences of text stored in additional training text storage 110. Specifically, morphological analysis unit 112 performs morphological analysis of each sentence while referring to dictionary 113 for morphological analysis, converts the sentence to a word sequence/phonetic letter sequence pair and outputs the pair to the first storage 114.

Training data generator 116 separates each word sequence/HIRAGANA pair stored in the first storage 114 to a word sequence 160 and a phonetic letter sequence 162, as shown in FIG. 4. Further, training data generator 116 concatenates word sequence 160 and phonetic letter sequence 162 to generate a concatenated character sequence 164. Training data generator 116 concatenates word sequence 160, concatenated character sequence 164 and phonetic letter sequence 162 in this order to generate training data 166. Here, at the head and tail of training data 166, tags representing head and tail are added, respectively. Further, at the borders between word sequence 160 and concatenated character sequence 164 and between concatenated character sequence 164 and phonetic letter sequence 162, tags indicating borders of character sequences are inserted. Training data 166 is stored in the third storage 118 shown in FIG. 2.

Pre-training unit 120 performs pre-training 168 of BERT using the pre-training data stored in the third storage 118. As a result, pre-trained BERT 170 is obtained as pre-trained language model 122 shown in FIG. 3. Parameters defined by pre-trained language model 122 are stored in prescribed storage.

### B. Additional Pre-Training

In the additional pre-training, language model training device 100 operates in the following manner.

Morphological analysis unit 112 performs the following process on each of the sentences of text stored in additional pre-training text storage 111. Specifically, morphological analysis unit 112 performs morphological analysis of each sentence while referring to dictionary 113 for morphological analysis, converts the sentence to a phonetic letter sequence, and outputs a word sequence/phonetic letter sequence pair to the second storage 115.

Noise-adding unit 124 performs the following process on each of the word sequence/phonetic letter sequence pairs stored in the second storage 115.

Referring to FIG. 6, word selector 314 of noise-adding unit 124 receives a word sequence 310 that is being processed, and selects therefrom, with a prescribed ratio, a word or words to which noise is to be added. Retrieving unit 318 reads, for each of the words selected by word selector 314, its phonetic letter sequence from the phonetic letter sequence 312, and extracts every word corresponding to the phonetic letter sequence that has the edit distance of one or two from the extracted phonetic letter sequence, from noise-adding dictionary 316. As a result, one or more words are extracted from noise-adding dictionary 316.

Replacement word determining unit 320 of noise-adding unit 124 selects one word from the one or more words extracted by retrieving unit 318, for each of the words as the objects of processing. In the present embodiment, this selection is done at random. Replacing unit 322 replaces, in accordance with the determination by replacement word determining unit 320, each word selected by word selector 314 and its phonetic letter sequence, with the word and its phonetic letter sequence determined by replacement word determining unit 320, and outputs, together with the original word sequence and phonetic letter sequence, as training data 324. The training data 324 is stored in the fourth storage 126 shown in FIG. 2.

Referring to FIG. 2, additional pre-training data generator 128 separates each word sequence/phonetic letter sequence pair stored in the fourth storage 126 to word sequence 160 and phonetic letter sequence 162, as shown in FIG. 4. Additional pre-training data generator 128 further forms a concatenated character sequence 164 by concatenating the word sequence 160 and phonetic letter sequence 162. Additional pre-training data generator 128 concatenates word sequence 160, concatenated character sequence 164 and phonetic letter sequence 162 in this order, to generated training data 166 for additional pre-training. At this time, at the head and tail of training data 166, tags indicating head and tail, respectively, are added, and at the border between word sequence 160 and concatenated character sequence 164 and at the border between concatenated character sequence 164 and phonetic letter sequence 162, tags indicating border between character sequences are inserted. The training data 166 for additional pre-training is stored in the fifth storage 130 shown in FIG. 2.

Additional pre-training unit 132 performs additional pre-training on the pre-trained language model 122 using the additional pre-training data stored in the fifth storage 130. As a result, additionally pre-trained language model 134 is obtained. Parameters defined by the additionally pre-trained language model 134 are stored in prescribed storage.

In this manner, the additionally pre-trained language model 134 is generated. As will be described later with reference to the experiments, it is confirmed that the additionally pre-trained language model 134 is robust against speech recognition errors.

### 3. Modification

### A. First Modification

In the embodiment above, first, BERT is pre-trained to obtain pre-trained language model 122. Thereafter, noise is added to additional pre-training text to obtain additional pre-training data. Using the additional pre-training data, the pre-trained language model 122 is additionally trained. In the first pre-training, noise is not added. The present invention, however, is not limited to such an embodiment. The entire pre-training may be done by using noise-added training data. In that case, additional pre-training text storage 111, morphological analysis unit 112, dictionary 113 for morphological analysis, noise-adding unit 124, the fourth storage 126, additional pre-training data generator 128 and the fifth storage 130 shown in FIG. 2 may be used.

### B. Second Modification

In the embodiment above, pre-training is done first and then, additional pre-training is done using the noise-added training data. The present invention, however, is not limited to such an embodiment. By way of example, when there is a language model realized by BERT (pre-training language model) that is pre-trained by using some data, only the additional pre-training using the noise-added training data may be conducted on the pre-trained language model. In that case also, a configuration similar to that of the first modification may be used.

### C. Third Modification

In the first and second modifications above, noise-added training data is used for the pre-training. The present invention, however, is not limited to such an embodiment. The training data to which noise is added by the same method as in the first embodiment may be used for fine-tuning in order to adapt a pre-trained language model to a specific application, rather than for the additional pre-training. In this case, labels appropriate for the task will be added to the training data. The third modification below is directed to such fine-tuning.

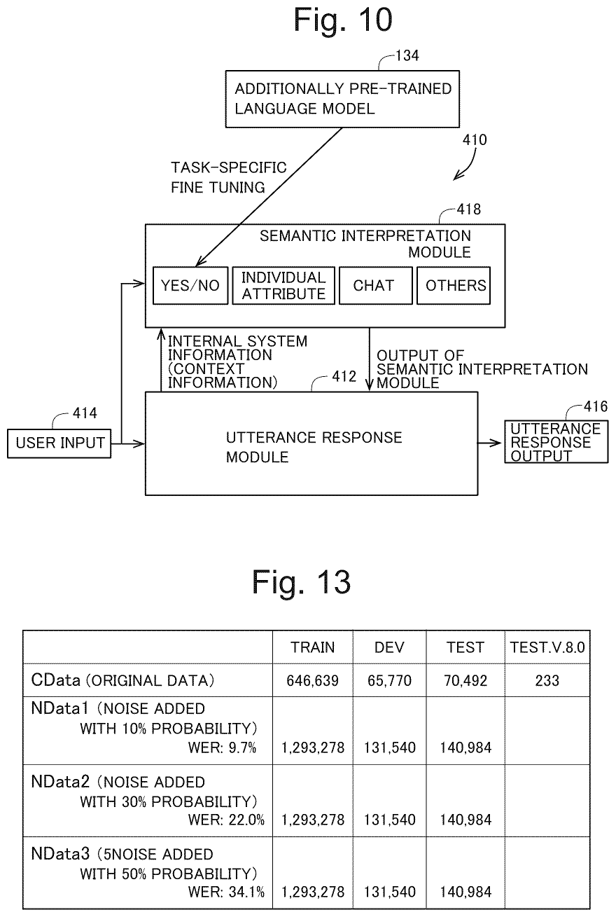

Prior to the description of the third modification, an example of application to which the pre-trained language model in accordance with the present embodiment is applied will be described. FIG. 10 schematically shows an assumed dialogue system 410. The dialogue system 410 shown in FIG. 10 is assumed to realize dialogue with the user with a prescribed purpose. For example, it is assumed that by utilizing a function of an utterance/response module 412, a question is given to the user, and, through communication, information of the user related to physical conditions or current status is collected. Here, dialogue with the user is basically speech-based, and use of the additionally pre-trained language model 134 in accordance with the present embodiment is helpful to improve the performance of an utterance/dialogue module.

On the user input 414 (obtained by speech recognition of user utterance (speech information), converting the result to text and further by transforming the text to phonetic letter sequence through morphological analysis), utterance/response module 412 performs basic utterance and response process, and outputs an utterance response output 416. In order to realize dialogue control with higher accuracy, a semantic interpretation module 418 is also used. Semantic interpretation module 418 is provided to receive user input 414 and internal system information of utterance/response module 412 (information related to the context of interaction response, which differs depending on the tasks) for realizing not only formulaic dialogue but also natural interaction. In order to interpret complicated user input that is not formulaic, various tasks are defined, and additionally pre-trained language model 134 is fine-tuned for the tasks. Thus, it becomes possible for semantic interpretation module 418 to obtain, by inference, information necessary for utterance/response module 412 to realize various tasks and to output it to utterance/response module 412. Using the output from semantic interpretation module 418, utterance/response module 412 outputs the utterance response output 416.

The tasks may include YES/NO determination (a type of classification task for classifying answers to a plurality of categories), determination of individual attribute (specifying information as to whether a question related to one's preference is answered, and extraction of keywords from the answers), and chat (a task for finding user utterances appropriate for starting/ending chat). These tasks all include inference based on the inputs. Using training data appropriate for each task, additionally pre-trained language model 134 is fine-tuned. In the following, an example in which the pre-trained language model is applied to YES/NO determination as an example of the task will be described in greater detail.

For example, assume a task of classifying answers to a question into a plurality of categories. Here, the question and an assumed answer candidate are turned to a set of word sequence, and their readings are turned to a phonetic letter sequence, and the word sequence and the phonetic letter sequence are treated as the word sequence/phonetic letter sequence pair in the above-described embodiment. By adding a label indicating the category of the answer candidate to the word sequence/phonetic letter sequence pair, training data is generated. The learning itself is the same as typical supervised learning.

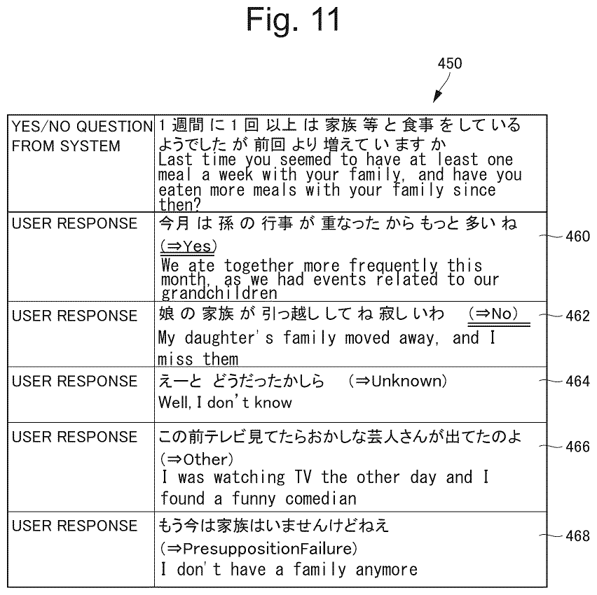

FIG. 11 shows an example of training data for fine tuning in this case. This is an example to be used in the subsequent experiments.

Referring to FIG. 11, this example 450 assumes a situation in which a robot asks an elderly person about living conditions. Here, the robot is referred to as a “system.” Generally, when one asks about the living conditions of an elderly person, there are questions for which a YES/NO response is expected, and questions for which more open-ended response is expected. In this example, an answer, for which a YES/NO response is expected, is given and the response thereto is classified into any of five categories, including YES/NO.

Suppose the asked question is “Last time you seemed to have at least one meal a week with your family, and have you eaten more meals with your family since then?” If there is a response 460 “We ate together more frequently this month, as we had events related to our grandchildren,” it belongs to the “YES” category. A response 462 “My daughter's family moved away, and I miss them” belongs to the “NO” category. A response 464 “Well, I don't know” is also possible. This response 464 should be categorized into “Unknown.” A response 466 “I was watching TV the other day and I found a funny comedian” is not related to the question at all and, therefore, it belongs to “Other” category. Finally, a response 468 “I don't have a family anymore” indicates that the given question was inappropriate. Therefore, the category of this response 468 is “Presupposition Failure.”

Most of the responses can be classified into any of these categories. Therefore, in this example, labels corresponding to these five categories may be added to the noise-added training data for fine-tuning.

For this type of task, using speech recognition of the counterpart's response is necessary. For errors in speech recognition, use of BERT fine-tuned in accordance with the present modification is effective. In the semantic interpretation module, the recognition result of speech information, which is the user input, (as well as a phonetic letter sequence after morphological analysis) and context information such as the question sentence from the system issued to obtain the user input, are fed to a trained language model for YES/NO determination, which infers and outputs probabilities that the user's response is classified into the above-described five categories. The output of trained language model (output of semantic interpretation module 408) for YES/NO determination is supplied to utterance/response module 402, used for YES/NO determination of vague user inputs, and reflected on subsequent utterance/response.

By fine-tuning BERT to be suitable for YES/NO determination, the above-described trained language model for YES/NO determination is obtained.

FIG. 12 shows an example of noise-added training data used in the present embodiment. Referring to FIG. 12, the training data 500 uses the same question as that shown in FIG. 11 as the question from the system. In place of response 460 shown in FIG. 11, noise-added response candidates such as response candidates 510, 512, 514 and 516 are used. Response candidates 510, 512, 514 and 516 are prepared by adding 0% noise, 10% noise, 30% noise and 50% noise, respectively, to the user response 464 shown in FIG. 11. Of the training data, the training data with 10% noise added represents the training data in which 10% of all words are replaced by noise. The same applies to the 30% noise and 50% noise.

As will be described later, by using the BERT fine-tuned using such training data, a trained language model is obtained. This trained language model enabled robust speech recognition with respect to the user's response, and higher classification accuracy of responses was confirmed. The trained language model is obtained by fine-tuning pre-trained BERT for each task. Therefore, if the task is an inference task using a language, by fine-tuning BERT in accordance with the present embodiment using appropriate training data in accordance with the contents and using this for inference, a high-performance trained language model can be realized.

### 4. Effects

As will be described later, the above-described embodiments enable robust speech recognition. Further, what is necessary to generate training data for pre-training is text processing only. Computational cost is far lower than what is disclosed in Non-Patent Literature 1. Further, the performance of finally obtained language model does not depend either on the speech synthesizer or the speech recognizer used for training. As a result, learning with low cost becomes possible and highly accurate language model can be obtained. This language model does not depend on the speech recognizer. Therefore, no matter what speech recognizer is used in the task to which the language model is applied, there is no need of re-training. Further, as the pre-trained language model is used, a robust trained language model can be realized.

In the embodiments above, BERT is trained by using BERT LARGE. As is apparent from the description above, the present invention is applicable not only to BERT LARGE but also to a large-scale language model that uses the pre-training manner similar to that of BERT. For example, it is known that BERT includes a large-scale BERT LARGE and a small-scale BERT BASE. By the same manner as in the embodiments above, a high-performance language model can also be obtained for BERT BASE. Though BERT BASE has far smaller configuration than BERT LARGE, it sometimes attains high performance comparable to BERT LARGE. Therefore, BERT BASE may be applicable to technical fields different from BERT LARGE. Both BERT BASE and BERT LARGE trained in accordance with the embodiments and modifications above will be referred to as “HIRAGANA BERT” or “HBERT” to save space in the present specification.

### II. Experiments

### A. Settings for Experiments

In the experiments, the task for classifying responses to system questions described with reference to the third modification above was adopted, and HIRAGANA BERT was fine-tuned for this purpose.

FIG. 13 shows statistics of data set used in the fine-tuning of HIRAGANA BERT used in the experiments. Referring to FIG. 13, CData represents manually prepared clear, noise-free Data. NData1, NData2 and NData3 respectively represent noise-added data automatically formed based on CData, added to the training data in the form of 1+1, that is, original data 1+noise-added data 1. The noise was generated by replacing words selected at random from the training data with words having similar readings as the selected words, as pseudo speech recognition error, as described with reference to the embodiments above. In the experiments also, the words for replacement are limited to those having edit distance of one or two from the original word phonetic letter sequence.

NData1, NData2 and NData3 differ in their noise addition probabilities. In NData1, noise is added to words with the probability of 10%. The Word Error Rate (WER) of this dataset was 9.7%. In NData2, noise is added to words with the probability of 30%. WER of NData2 was 22.05%. In NData3, noise is added to words with the probability of 50%. WER of NData3 was 34. 15%.

In FIG. 13, “TRAIN” column indicates the number of sentences used for fine-tuning. “DEV” indicates the number of sentences of development data used at the time of selecting hyper parameters. “test” indicates the number of sentences of test data prepared for checking accuracy in advance. “test.v.8.0” represents actual dialogue data obtained at the demonstration experiment, indicating the number of sentences used for evaluating the finally obtained HIRAGANA BERT.

FIG. 14 shows statistics data of training data used for pre-training of HIRAGANA BERT in the experiments.

Referring to FIG. 14, in the experiments, two types of HIRAGANA BERT were used. Both HIRAGANA BERT were language models based on BERT LARGE pre-trained by 1 million steps using as training data 2.2 billion causality sentences extracted from Japanese sentences collected in advance from the Internet, and additionally trained in accordance with the embodiments above.

The first HIRAGANA BERT was additionally trained by using as training data 18.4 million sentences from Wikipedia on the Internet, adopting the format of maximum length of input=768 words (word sequence+phonetic letter sequence) with 100,000 training steps and batch size of 1024. In the following, this first HIRAGANA BERT will be denoted as HBERT LARGE_{wiki,100k}.

The second HIRAGANA BERT was additionally trained by using as additional training data the 2.2 billion causality sentences used for training BERT LARGE, with the maximum length of 768, training steps of 200,000 and batch size of 1024. In the following description, this first HIRAGANA BERT will be denoted as HBERT LARGE_{Cs,200k}.

Hyper parameter values of these were selected from the following, based on evaluation of Average Precision of HIRAGANA BERT using development data.
Learning rate (lr); {1e-5, 2e-5, 3e-5, 4e-5, 5e-5, 6e-5}
Epoch number (epoch): {1, 2, 3, 4}
Batch size: 256
Maximum length: 128

### B. Results of Experiments

FIG. 15 shows the results of experiments. In the table of FIG. 15, the left-most column indicates names of datasets used for fine-tuning and as development data. The second column indicates the names of used models and parameters at the time of their training. The third column indicates average precision of each model for the development model. The fourth column shows average precision of each model for the test data. The fifth column shows average precision of each model for the demonstration experiment data (text.v8.0).

Of these results, the most important is the performance of each model with respect to the substantive experiment data (fifth column). Focusing on this point, it can be seen that HBERT LARGE_{Wiki,100k} attained the highest performance. Particularly, it is noted that the performance of HBERT LARGE_{Wiki,100k} fine-tuned using the dataset Ndata3 having high noise probability was the highest. Besides, regarding the performance with respect to the demonstration experiment data, both HBERT LARGE_{Wiki,100k} and HBERT LARGE_{Cs,200k} were confirmed to attain higher performances than BERT LARGE before fine-tuning.

### III. Computer Implementation

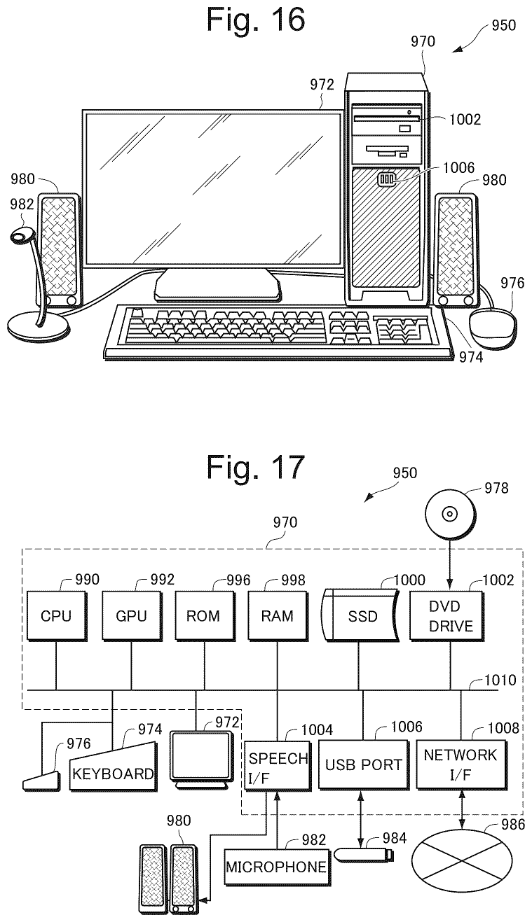

FIG. 16 shows an appearance of a computer system functioning as the language model training device 100 shown in FIG. 2. FIG. 17 is a hardware block diagram of the computer system shown in FIG. 16. The computer is connected, for example, to a computer of the counterpart's home through the Internet and realizes automatic dialogue with the counterpart by means of images, speeches, and a microphone. Alternatively, the computer is used connected to a robot that interacts with the counterpart. By using a smaller computer, it is also possible to embed the computer in a robot that interacts with the counterpart.

Referring to FIG. 16, the computer system 950 includes: a computer 970 having a DVD (Digital Versatile Disc) drive 1002; and a keyboard 974, a mouse 976 and a monitor 972, all connected to computer 970 for interaction with the user. These are examples of equipment when user interaction becomes necessary, and any other general hardware and software (for example, a touch-panel, voice input, pointing device and so on) allowing user interaction may be used.

Referring to FIG. 17, computer 970 includes: in addition to DVD drive 1002, a CPU (Central Processing Unit) 990, a GPU (Graphics Processing Unit) 992, a bus 1010 connected to CPU 990, GPU 992, and DVD drive 1002, a ROM (Read Only Memory) 996 connected to bus 1010 for storing a boot up programs and the like of computer 970, a RAM (Random Access Memory) 998 connected to bus 1010, for storing program instructions, a system program and work data, and an SSD (Solid State Drive) 1000, which is a non-volatile memory connected to bus 1010. SSD 1000 is for storing programs executed by CPU 990 and GPU 992, data used by the programs executed by CPU 990 and GPU 992 and so on. Computer 970 further includes a network I/F (Interface) 1008 providing connection to a network 986 allowing communication with other terminals; and a USB (Universal Serial Bus) port 1006 to which a USB memory 984 may be detachably attached, providing communication with USB memory 984 and different units in computer 970.

Computer 970 further includes: a speech I/F 1004 connected to a microphone 982, a speaker 980 and bus 1010, reading out a speech signal, a video signal and text data generated by CPU 990 and stored in RAM 998 or SSD 1000 under the control of CPU 990, to convert it into an analog signal, amplify it, and drive speaker 980, or digitizing an analog speech signal from microphone 982 and storing it in addresses in RAM 998 or in SSD 1000 specified by CPU 990.

In the embodiments described above, programs realizing various functions of language model training device 100, programs realizing HIRAGANA BERT and their parameters are stored, for example, in SSD 1000, RAM 998, DVD 978 or USB memory 984 shown in FIG. 17, or in a storage medium of an external device, not shown, connected through network I/F 1008 and network 986. Typically, the data and parameters are written from the outside to SSD 1000, for example, and at the time of execution by computer 970, loaded into RAM 998.

Computer programs causing the computer system to operate to realize functions of the language model training device 100 shown in FIG. 2 and its various components are stored in DVD 978 loaded to DVD drive 1002 and transferred from DVD drive 1002 to SSD 1000. Alternatively, these programs are stored in USB memory 984, and by attaching the USB memory to USB port 1006, the programs may be transferred to SSD 1000. Further alternatively, the programs may be transmitted through network 986 to computer 970 and stored in SSD 1000.

At the time of execution, the programs will be loaded into RAM 998. Naturally, source programs may be input using keyboard 974, monitor 972 and mouse 976, and the compiled object programs may be stored in SSD 1000. When a script language is used, scripts input through keyboard 974 or the like may be stored in SSD 1000. For a program operating on a virtual machine, it is necessary to install programs that function as a virtual machine in computer 970 beforehand. For speech recognition and speech synthesis, trained neural networks may be used, or training may be done in the language model training device 100.

CPU 990 fetches an instruction from RAM 998 at an address indicated by a register therein (not shown) referred to as a program counter, interprets the instruction, reads data necessary to execute the instruction from RAM 998, SSD 1000 or from other device in accordance with an address specified by the instruction, and executes a process designated by the instruction. CPU 990 stores the resultant data at an address designated by the program, of RAM 998, SSD 1000, register in CPU 990 and so on. In an embodiment using a robot, the resultant data may be output as an instruction to actuators of the robot or speech signals, from the computer. At this time, the value of program counter is also updated by the program. The computer programs may be directly loaded into RAM 998 from DVD 978, USB memory 984 or through the network. Of the programs executed by CPU 990, some tasks (mainly numerical calculation) may be dispatched to GPU 992 by an instruction included in the programs or in accordance with a result of analysis during execution of the instructions by CPU 990.

The programs realizing the functions of various units in accordance with the embodiments above by computer 970 may include a plurality of instructions described and arranged to cause computer 970 to operate to realize these functions. Some of the basic functions necessary to execute the instruction are provided by the operating system (OS) running on computer 970, by third-party programs, or by modules of various tool kits installed in computer 970. Therefore, the programs may not necessarily include all of the functions necessary to realize the system and method in accordance with the present embodiment. The programs have only to include instructions to realize the functions of the above-described various devices or their components by statically linking or dynamically calling appropriate functions or appropriate “program tool kits” in a manner controlled to attain desired results. The operation of computer 970 for this purpose is well known and, therefore, description thereof will not be repeated here.

It is also possible to directly control the computer by the programs without installing any OS.

It is noted that GPU 992 is capable of parallel processing and capable of executing a huge amount of calculation accompanying machine learning simultaneously in parallel or in a pipe-line manner. By way of example, parallel computational element found in the programs during compilation of the programs or parallel computational elements found during execution of the programs may be dispatched as needed from CPU 990 to GPU 992 and executed, and the result is returned to CPU 990 directly or through a prescribed address of RAM 998 and input to a prescribed variable in the program.

### IV. Further Modification

The above-described embodiments assume Japanese as the object language. As phonetic symbols as a result of conversion from KANJI characters, HIRAGANA, which is one type of phonogram, is used. The present invention, however, is not limited to such embodiments. When Japanese is the object, KATAKANA, another type of phonogram, may be used as the phonetic letters, or Roman alphabet may be used. In any case, though the dictionary configuration must be changed to some extent, the manner of pre-training, additional pre-training and fine-tuning the language model is the same as in the embodiments above. Further, as the phonogram, other than those mentioned above, pronunciation symbols and the like may be used.

The same applies when the object language is not Japanese. By way of example, if there is any symbol system (such as pronunciation symbols) that represents pronunciation of words by some sign or symbol, the present invention is applicable to any language using such a symbol system. In that case, the present invention is applicable when one character (one symbol) represents one phoneme, or it represents one syllable or one mora.

Further, in the embodiment above, for each word of the word sequence that is being processed, first, whether the word is to be replaced with noise or not is determined at random, as shown in FIG. 8. Thereafter, the process of replacing with noise is executed only on the word or words that are determined to be replaced. The present invention, however, is not limited to such embodiments. For example, the word to be replaced may be determined by some method. Replaceable words may be limited in some way. For every word, a noise word for replacement may be determined and then, the word to be actually replaced by the noise may be determined. Further, the upper limit of edit distance when words having similar phonetic letter sequence are to be selected is not limited to two, and it may be one, or three or more. Depending on language, this value may be larger.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

100 language model training device
110 pre-training text storage
111 additional pre-training text storage
112 morphological analysis unit
113 dictionary for morphological analysis
114 first storage
115 second storage
116 training data generator
118 third storage
120 pre-training unit
122 pre-trained language model
124 noise-adding unit
126 fourth storage
128 additional pre-training data generator
130 fifth storage
132 additional pre-training unit
134 additionally pre-trained language model
140 word sequence/phonetic letter sequence
150 training process
160, 310 word sequence
162, 312 phonetic letter sequence
164 concatenated character sequence
166, 200, 324, 500 training data
168 pre-training
170 BERT
210, 212, 214, 220, 222, 224 mask
226 MLM
230, 232 word
314 word selector
316 noise-adding dictionary
318 retrieving unit
320 replacement word determining unit
322 replacing unit
332 training data adding process
342 word replacement process
400, 402 phonetic letter sequence set
410 dialogue system
412 utterance/response module
418 semantic interpretation module

1. A language model training device, comprising:
a converting means for converting natural language text to output a sequence of phonetic letters; and
a training means for training a language model using said text and said sequence of phonetic letters output from said converting means.

2. The language model training device according to claim 1, wherein said training means includes:
training data forming means for forming training data for training said language model by combining said text and the sequence of phonetic letters output from said converting means; and
a pre-training means for pre-training said language model using said training data.

3. The language model training device according to claim 2, further comprising:
a noise adding means for adding noise to said sequence of phonetic letters to generate a noise-added sequence of phonetic letters;
a training data forming means for forming training data for fine-tuning said language model pre-trained by said pre-training means, using said text, said sequence of phonetic letters and said noise-added sequence of phonetic letters; and
a fine-tuning means for fine-tuning said pre-trained said language model by using said training data.

4. The language model training device according to claim 1, wherein said language model includes a pre-trained language model;
said training means includes:
a noise adding means for adding noise to said sequence of phonetic letters to generate a noise-added sequence of phonetic letters;
a training data forming means for forming training data for fine-tuning said language model pre-trained by said pre-training means, using said text, said sequence of phonetic letters and said noise-added sequence of phonetic letters; and
a fine-tuning means for fine-tuning said pre-trained language model by using said training data.

5. The language model training device according to claim 1, wherein said language model includes a pre-trained language model;
said training means includes:
a noise adding means for adding noise to said sequence of phonetic letters to generate a noise-added sequence of phonetic letters;
an additional training data forming means for forming additional training data for additionally training said pre-trained language model, using said text, said sequence of phonetic letters and said noise-added sequence of phonetic letters; and
an additional pre-training means for additionally pre-training said pre-trained language model using said training data.

6. A dialogue device realizing speech-based dialogue with a user, comprising:
a trained language model generated by machine learning using at least natural language text and a sequence of phonetic letters obtained by converting the text;
a semantic interpretation module with said trained language model, for receiving as an input speech information of said user; and
an utterance/response module for receiving as an input the speech information of said user and for executing a dialogue with the user under control of said semantic interpretation module.

7. A trained language model generated by machine learning, using at least natural language text and a sequence of phonetic letters obtained by converting the text.
